(19) United States
(12) Patent Application Publication
(10) Pub. No.: US 2014/0212855 A1
(43) Pub. Date: Jul. 31, 2014

(54) Fitness System And Method For Determining An Exercise Routine

(71) Applicant: Elizabeth T. Robinson, Philadelphia, PA (US)

(72) Inventor: Elizabeth T. Robinson, Philadelphia, PA (US)

(21) Appl. No.: 13/749,983

(22) Filed: Jan. 25, 2013

(51) Int. Cl. G09B 19/00

(52) U.S. Cl. CPC G09B 19/00
USPC 434/247

(57) ABSTRACT

The present disclosure relates to a fitness system which includes an input device; a display device; and a processor. The processor is configured to transmit a survey to a user, wherein the survey comprises a plurality of questions related to the physical or performance abilities of the user for a predetermined plurality of exercises; receive answers to the survey from the input device; determine a suggested exercise routine based on at least the answers to the survey; and transmit the suggested exercise routine to the user.

### BACKGROUND OF THE DISCLOSURE

The present disclosure is related to a fitness system for providing a customized and evolving exercise routine to a user. In particular, the present disclosure is related to a fitness system configured to remotely determine an optimized workout routine without visual observation.

The benefits of exercising are well known and researched. However most individuals who are new to exercising or inexperienced in exercise techniques seek out the input and guidance of a personal trainer. A personal trainer visually observes an individual to determine weak muscle groups, evaluates the abilities of the individual in performing various exercise routines, and the individual's comfort in using various exercise equipment. A personal trainer balances these observations and evaluations against the goals of an athlete in tailoring a physical fitness program that meets the needs of the individual. A personal trainer can also teach the individual how to perform the exercise, use the fitness equipment, and provide encouragement.

Individuals who are either uncomfortable with using a personal trainer, unable to afford a personal trainer's service, or secure the availability of a quality personal trainer need to have alternatives that can provide, for example, an accurate assessment, tracking, and management of an individual's fitness goals.

Moreover, for a fitness trainer, there is a lack of an available tool which allows the personal trainer to optimize the intake, evaluation, and management process of their clients. For example, the relationship between a personal trainer and a client is traditionally a one on one environment, preventing the trainer from working with more than one client at a given time. Therefore, there is a need to provide a fitness system which will help a fitness trainer have a higher capacity of clients serviced remotely, that ensures the ability to provide customized care.

### BRIEF DESCRIPTION OF THE DISCLOSURE

A first aspect of the disclosure is directed to a fitness system which includes an input device; a display device; and a processor. The processor is configured to transmit a survey to a user, wherein the survey comprises a plurality of questions related to the physical or performance abilities of the user for a predetermined plurality of exercises; receive answers to the survey from the input device; determine a suggested exercise routine based on at least the answers to the survey; and transmit the suggested exercise routine to the user.

Another aspect of the disclosure is directed to the above fitness system, wherein the processor is further configured to transmit a second survey to the user, wherein the second survey comprises questions which relate to the performance of the suggested exercise routine; receive answers to the second survey from the input device; determine a suggested subsequent exercise routine; and transmit the suggested subsequent exercise routine to the user.

Yet another aspect of the disclosure is directed to the above fitness system, wherein the processor is further configured to communicate with a third party device, and wherein the third party device is configured to communicate with the processor to manipulate the suggested exercise routine.

Yet a further aspect of the disclosure is directed to a method of remotely determining a suggested exercise routine including transmitting a survey to a user, wherein the survey comprises a plurality of questions, wherein the plurality of questions comprise questions which relate to the physical abilities of the user for a predetermined plurality of exercises; receiving answers to the survey from an input device; determining a suggested subsequent exercise routine based on at least the answers to the survey using a processor; and transmitting the suggested subsequent exercise routine to a display device.

### BRIEF DESCRIPTION OF THE DRAWINGS

FIG. 1 illustrates a fitness systems according to an embodiment of the present disclosure.

FIG. 2 illustrates a fitness systems according to an embodiment of the present disclosure.

FIG. 3 illustrates a fitness systems according to an embodiment of the present disclosure.

FIG. 4 illustrates a fitness systems according to an embodiment of the present disclosure.

FIG. 5 illustrates a fitness systems according to an embodiment of the present disclosure.

FIG. 6 illustrates a fitness systems according to an embodiment of the present disclosure.

Skilled artisans appreciate that elements in the figures are illustrated for simplicity and clarity and have not necessarily been drawn to scale. For example, the dimensions of some of the elements in the figures can be exaggerated relative to other elements to help improve understanding of embodiments of the invention. The use of the same reference symbols in different drawings indicates similar or identical items.

### DETAILED DESCRIPTION OF THE DISCLOSURE

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The following disclosure is generally directed to fitness systems and method for remotely determining an optimized workout routine. In embodiments disclosed herein, a fitness system which can determine weak fitness aspects of the user based on a standardized survey of the performance of a user in a plurality of exercise routines. The fitness system can then determine an optimized subsequent exercise routine that targets the weak fitness aspects of the user (even weak fitness aspects unknown to the user) and suggests exercises and exercise equipment to best meet the user's fitness goals. The fitness system can further include audio recordings which are correlated with the suggested exercise routines which can coach the user through the suggested exercise routines.

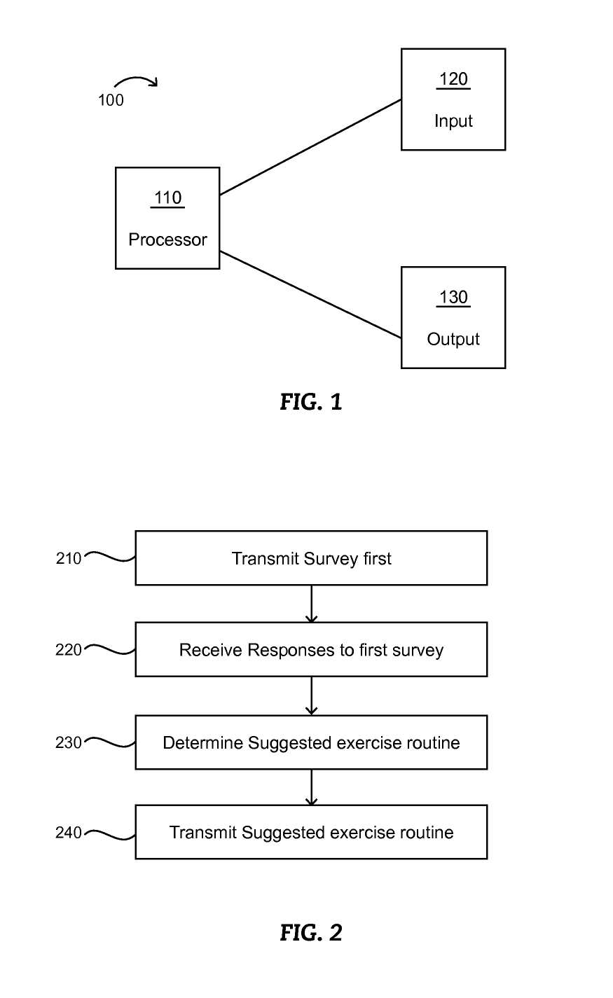

Referring now to FIG. 1, a fitness system 100 generally includes a processor 110, an input device 120, and an output device 130. In certain embodiments, the input device and output device can include any device which is configured to communication with a processor and a user. For example, the input device and output device can include a computer, a mobile device, a component thereof, or a combination thereof. The input device and the output device can be the same or different device.

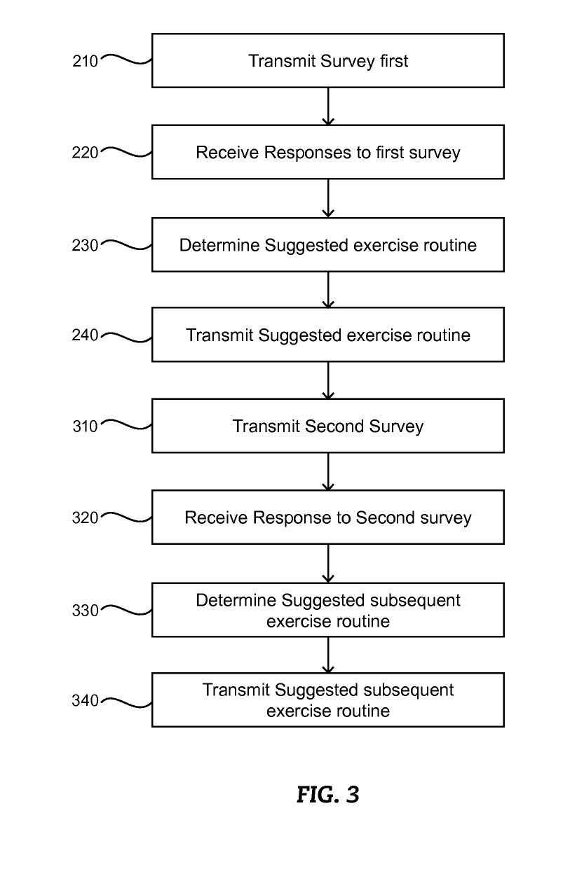

Referring now to FIG. 2, the processor 110 can be configured to transmit a survey to a user 210; receive answers to the survey provided by the user 220; determine a suggested exercise routine based on the answers 230; and transmit the suggested exercise routine to the user 240. In particular embodiments, the survey contains questions which relate to the physical or performance abilities of the user. As further illustrated in FIG. 3, the processor 110 can further be configured to transmit a second survey to the user 310; receive answers to the second survey from the input device 320; determine a suggested subsequent exercise routine 330; and transmit the suggested subsequent exercise routine to the user 340. In particular embodiments, the second survey includes questions which relate to the performance of the user with the suggested exercise routine. It is to be understood that the steps recited in FIG. 3 can be repeated as long as the user continues using the fitness system. Moreover, it is to be understood that the fitness goals of the user, as described in more detail below, may influence the suggested subsequent exercise routines determined by the processor.

In particular embodiments, the fitness system is configured to determine the suggested exercise routines without a visual observation influencing the suggested exercise routine. A particular advantage of the fitness system described herein includes the ability to accurately optimize a exercise routine without requiring a visual observation component. Such embodiments eliminate the need for a trainer to be physically present during the exercise routines.

Referring again to FIG. 1, in particular embodiments, the survey can contain questions related to initial parameters to characterize, for example, the appropriateness of an exercise or the level of exercising physiologically suitable for the user. For example, the survey may include questions related to, for example, medical questions, physical measurement questions, well-being questions, and combinations thereof. The survey can also be configured to provide an indication of the user's activity level, for example, as a conditioned user or a sedentary user.

In certain further embodiments, the survey can contain questions related to a fitness assessment of the user. In particular embodiments, the questions related to a fitness assessment can include questions related to categories including upper body strength, leg strength, core strength, flexibility, and combinations thereof. The questions related to upper body strength can include questions asking the user to identify their capabilities in exercises such as, for example, bicep curl, tricep extension, overhead press, push ups, and combinations thereof. The questions related to leg strength can include questions asking the user to identify their capabilities in exercises such as, for example, side-lying leg lift, wall sit, heel lifts, and combinations thereof. The questions related to core strength can include questions asking the user to identify their capabilities in exercises such as, for example, crunch tests, forearm plank, superman, and combinations thereof. The questions related to flexibility can include questions asking the user to identify their capabilities in exercises such as, for example, sit and reach, heel grab, and combinations thereof.

In further embodiments, the survey can contain questions related to the cardio fitness of the user. In certain embodiments, the questions related to the cardio fitness of the user can include the user's resting heart rate, the user's active heartrate after performing a prescribed exercise. For example, a comparison can be made between the user's active heartrate and their resting heartrate to provide an indication of the cardio fitness of the user.

The questions related to a fitness assessment can further include questions asking the user to identify the maximum amount of weight that can be accomplished by the user for a particular exercise and for a predetermined number of repetitions; the maximum amount of repetitions that can be accomplished by the user for a particular exercise and, in certain embodiments, with a particular weight or for a predetermined time; the maximum amount of time a particular position could be held for a particular exercise; the length of reach that could be accomplished by the user; and combinations thereof.

As discussed above, the survey can further include questions related to the user's fitness goals. For example, the survey may contain questions related to the fitness goals of the user in categories such as weight loss, weight gain, muscle tone, increased balance, increased flexibility, doctor's orders, increase in endurance, build muscle, and combinations thereof.

In certain further embodiments, the survey can include questions related to the last time the user exercised. The user's response to this question can be used to provide an indication of the user's activity level.

In certain further embodiments, the survey can include questions related to the currently used exercise style that the user uses, such as, for example, running, swimming, cycling, sports, weight lifting, walking, yoga/pilates, and combinations thereof. Similarly, the survey can include questions related to the desired or preferred types of exercise style that the user has available to them or that the user would like to use. For example, such desired or preferred types of exercise styles can include running, swimming, cycling, sports, weight lifting, walking, yoga/pliates, and combinations thereof. Moreover, in certain embodiments, the survey can include questions related to the physical location and exercise equipment that the user has access to or desires to use in their exercise routines. For example, the physical locations can include, for example, a fitness club or gym, outdoors, a yoga studio, swimming pool, or combinations thereof. For the fitness equipment, examples include hand weights, barbells, a medicine ball, a step bench, a balance ball, a body bar, a jumping rope, a BOSU ball, a treadmill, a stationary bicycle, and combinations thereof.

As discussed above, the processor can be configured to determine the suggested exercise routine based on the answers to the questions in the survey. It is to be understood that any number of combinations of the questions discussed herein can be used in the determination of the suggested exercise routine and the suggested subsequent exercise routine. In fact, it is a particular advantage of the present embodiments to optimize the suggested exercise routine for he particular individual user. Moreover, since the fitness system is capable of determining the weak performance characteristics of the user without a visual observation and instead based on the answers to the questions in the survey and any other user responses to already completed workouts and exercises.

To determine the suggested exercise routine, the processor can assign a ranking point value to a response to the questions in the survey. For example, if the question in the survey asks the user to identify the maximum weight of a barbell the user can lift in a bicep curl for 10 reps, the processor will assign a point value to the answer in relation to the skill level indicated by the answer. As such, if the user response 2 lbs, the processor can assign a point value of 0, but when the user responds with 25 lbs, the processor can assign a point value of 8. The similar assignation of relative point values for the given exercise can be repeated for any number of the questions in the survey.

In certain embodiments, the processor assigns a different point value and uses a different determination formula for men and women. For example, different performance expectations exists for men and women, and fitness goals, preferred exercise equipment, and the like can be different for men and women.

In addition to determining a suggested exercise routine, in certain embodiments, the fitness system can further be configured to receive and record information such as a user profile information, billing information, and the last time the user exercised. In particular embodiments, all of the user's exercise activity can be tracked, sorted, analyzed, and transmitted to third parties.

In certain embodiments, the suggested exercise routine can include a calendar that provides, for example, the frequency of the user's workouts, the workout styles, and the schedule of workouts, i.e. days for cardio workouts and days for strength training. The suggested exercise routine can further include the number of times an exercise is repeated, and the pace at which the exercise should be completed. The suggested workout routine can progress for the user such that the workouts gradually increase the effort exerted by the user by increasing repetitions or increasing load, i.e. weights, resistance levels, and/or pacing. As such, in certain embodiments, the workouts can be progressively more difficult.

In particular embodiments, the suggested exercise routine is the form of an audio coaching of the prescribed workout. The audio coaching can include a musical beat, such as a song or other melodious sounds. The musical beat can be selected such that regulates the pace of the exercise, and in particular, the user's heart rate. For example, musical beat can be selected to set the pace of the exercises and/or to count the repetitions and sets that a user completes during an exercise routine. This enables a quantification of the user's workout level, heart beat, and exercise stamina without being able to view the user.

The audio coaching can further include an instruction portion in which the user is provided instructions on the proper form and method for the particular exercise routine. The instruction portion can further provide information to the user such as the exercise's purpose, targeted muscle groups, and how to control breathing during the exercise routine. For example, when instructing a user on how to perform a squat, the audio coaching tells the user to bend their knees, inhale on the bend, transfer their weight to their heels, etc. The audio coaching can further include instructing the user through the pacing of the workout as it applies to the music they are hearing. For example, the audio coaching may instruct the user to drop down into a squat in two beats and return to upright standing position in 2 more beats. The beats can be clear and constant in the music (i.e. a separate sound than the song). Thus, the audio coaching can include slower beats for novice users and progressively increase in pace as the user progresses through the exercise routine or subsequent exercise routines.

In certain further embodiments, the second survey can include questions related to the overall experience of the user in performing the exercises in the suggested workout routine. For example, the questions can be qualitative or quantitative. The answers to the experience questions can be stored, tracked, or accessed by a third party device as discussed in more detail below. In certain embodiments, the processor can be configured to not generate a suggested subsequent exercise routine until the user provides feedback on the suggested exercise routine. In particular embodiments, the second survey includes questions which asks the user to qualitatively rank the ease or difficult of the full workout or each exercise component within the workout. The processor can be further configured to adjust the suggested subsequent exercise routine based in part on the answers to the ranking questions. In particular embodiments, the processor can be configured to adjust the suggested subsequent exercise routine that the user found to be more enjoyable or desirable styles of exercises.

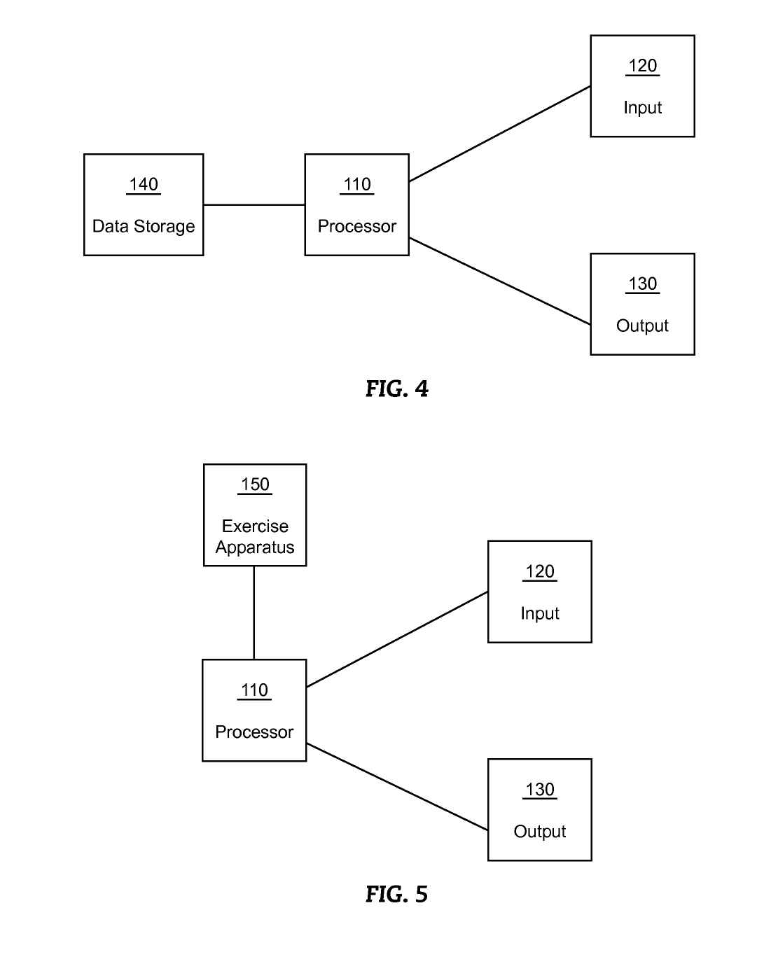

Referring now to FIG. 4, in certain embodiments, the fitness system 100 can further include a data storage device 140. The data storage device can record all of the user's exercise activity and survey responses. Moreover, in certain embodiments, the data storage device can include a plurality of audio exercise routines. The audio exercise routines can be related to the suggested exercise routines. For example, when the processor receives the data from the user and transforms the data into a suggested subsequent exercise routine, the processor can further be configured to match the suggested subsequent exercise with an audio recording which can be configured to guide or coach a user through the exercises in the suggested subsequent exercise routine. The particular audio recording can be a combination of audio recording for a plurality of different exercises which match the exercises determined for the suggested exercise routine.

Referring now to FIG. 5, the fitness system 100 can further comprise an exercise apparatus 150 in communication with the processor. The exercise apparatus can be configured to receive and transmit data including, for example, a user profile, exercise data, or combinations thereof. In certain embodiments, the exercise apparatus can communicate with a mobile device. For example, the exercise apparatus can be configured to communicate with the mobile device such that the exercise apparatus can receive the data stored on the mobile device without a prompting from the user. In certain embodiments, the exercise apparatus can include a near field communication device which is configured to allow communication between the mobile device and the exercise apparatus when the mobile device is within a predetermined range of the exercise apparatus.

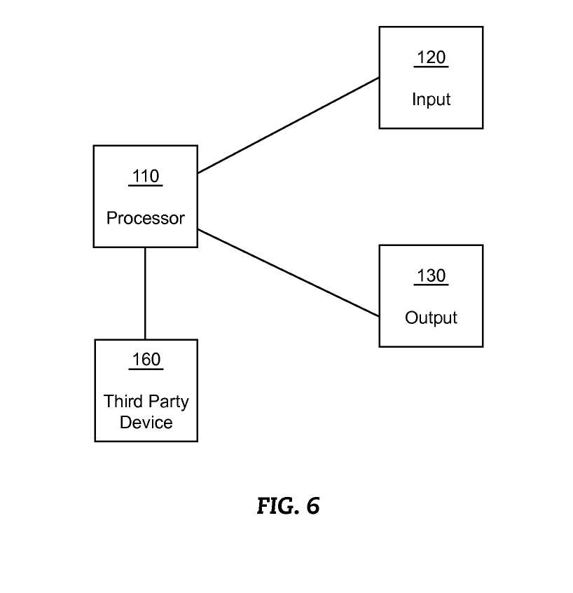

Referring now to FIG. 6, in certain embodiments, the processor 110 can further be configured to be in communication with a third party device 160. For example, the third party device can be controlled by a third party such as a fitness trainer or a fitness club. The processor can be configured to receive and transmit data to and from the third party device. For example, the data received from the third party device can be used to influence the outputted suggested exercise routine. Moreover, the data generated by the fitness system can be transmitted to or accessed by the third party to perform, for example, logging, recording, storing, aggregating, and analytics with the data.

In certain further embodiments, the third party device can receive or access data from multiple users. For example, data can be aggregated to determine effectiveness of exercise equipment, exercises styles, or exercise routines based on a plurality of user's data. In a particular example, the third party device can also be configured to communicate with the processor to determine currently active users, their location, their status, or even the particular exercise routine they are performing in realtime. In these embodiments, the third party device can allow access to all recorded data to determine analytics on aspects such as the frequency of use or the effectiveness of a particular exercise routine aggregated across multiple users.

In certain further embodiments, the processor can further be configured to be in communication with a different third party device. For example, the different third party device can be in controlled by an insurance company, and the processor can be configured to transmit data such as records of the user's exercise activity to the third party device controlled by an insurance company. The processor can further be configured to communicate with the different third party device to coordinate reimbursement of the cost of the fitness system or other reimbursable costs incurred by the user.

According to another aspect of the present disclosure, a method for remotely determining a suggested exercise routine can include transmitting a survey to a user, wherein the survey comprises a plurality of questions, wherein the plurality of questions comprise questions which relate to the physical abilities of the user for a predetermined plurality of exercises; receiving answers to the survey from an input device; determining a suggested subsequent exercise routine based on at least the answers to the survey using a processor; and transmitting the suggested subsequent exercise routine to a display device.

It is to be understood that the communication with the processor can occur over a network interface or modem which couples the input/output devices and processor to a data communications network such as an intranet, the Internet, to transmit and receive information.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A fitness system comprising:
a. an input device;
b. a display device; and
c. a processor, wherein the processor is configured to:
i. transmit a survey to a user, wherein the survey comprises a plurality of questions related to the physical or performance abilities of the user for a predetermined plurality of exercises
ii. receive answers to the survey from the input device,
iii. determine a suggested exercise routine based on at least the answers to the survey; and
iv. transmit the suggested exercise routine to the user.

2. The fitness system of claim 1, wherein the processor is further configured to
a. transmit a second survey to the user, wherein the second survey comprises questions which relate to the performance of the suggested exercise routine;
b. receive answers to the second survey from the input device; and
c. determine a suggested subsequent exercise routine; and
d. transmit the suggested subsequent exercise routine to the user.

3. The fitness system of claim 1 wherein the survey comprises questions related to the user's fitness goals, and wherein the processor is configured to determine the suggested exercise routine based on, at least, the user's fitness goals.

4. The fitness system of claim 1, wherein the survey comprises questions related to desired exercise styles and wherein the processor is configured to determine the suggested exercise routine based on, at least, the desired exercise styles.

5. The fitness system of claim 1, wherein the survey comprises questions related to fitness equipment available to the user, and wherein the processor is configured to determine the exercise routine based on, at least, the fitness equipment available to the user.

6. The fitness system of claim 1, wherein the survey comprises questions related to medical conditions or limitations, and wherein the processor is configured to determine the exercise routine based on, at least, the medical conditions or limitations.

7. The fitness system of claim 1, wherein the questions related to the physical abilities of the user comprises questions related to at least one category selected from the group consisting of upper body strength, leg strength, core strength, flexibility, and combinations thereof.

8. The fitness system of claim 7, wherein answers to the questions related to the physical abilities of the user are in the form of a numerical indication of a maximum performance ability for a plurality of exercises.

9. The fitness system of claim 1, wherein the suggested exercise routine is the form of an audio coaching of the prescribed workout, and wherein the audio coaching comprises a musical beat which is preselected to maintain a user's heart rate.

10. The fitness system of claim 1, wherein the fitness system further comprises a data storage device, wherein the data storage device comprises a plurality of audio recordings of exercise routines, and wherein the processor is further configured to transmit an audio exercise routine with the suggested exercise routine.

11. The fitness system of claim 1, wherein the input or output device comprises a mobile device.

12. The fitness system of claim 1, further comprising an exercise apparatus in communication with the processor or mobile device, wherein the exercise apparatus is configured to record and transmit data used by the processor to identify the user or to determine the suggested exercise routine.

13. The fitness system of claim 12, wherein the exercise apparatus comprises a near field communication device which is in communication with the processor or mobile device.

14. The fitness system of claim 1, wherein the processor is further configured to transmit and receive data between a third party device and the user.

15. The fitness system of claim 14, wherein the third party device is controlled by a fitness trainer or a fitness club.

16. The fitness system of claim 14, wherein the processor is configured to notify the third party device when the user is communicating with the processor.

17. The fitness system of claim 16, wherein the third party device is configured to transmit words of encouragement, an advertisement, or request feedback from the user.

18. The fitness system of claim 16, wherein the processor is configured to allow the third party device to view or manipulate the suggested exercise routine.

19. The fitness system of claim 1, wherein the fitness system further comprises a mobile device, and wherein the mobile device is configured to provide an indication to the fitness system when the mobile device is within range of a predetermined exercise location.

20. A method of remotely determining a suggested exercise routine comprising:
a. transmitting a survey to a user, wherein the survey comprises a plurality of questions, wherein the plurality of questions comprise questions which relate to the physical abilities of the user for a predetermined plurality of exercises;
b. receiving answers to the survey from an input device,
c. determining a suggested subsequent exercise routine based on at least the answers to the survey using a processor; and
d. transmitting the suggested subsequent exercise routine to a display device.
